(19) United States
(12) Patent Application Publication
(10) Pub. No.: US 2005/0190715 A1
(43) Pub. Date: Sep. 1, 2005

(54) Communications system, method and devices

(75) Inventor: Darren Phillip McNamara, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/034,812

(22) Filed: Jan. 14, 2005

(30) Foreign Application Priority Data
Feb. 27, 2004 (GB) 0404449.1

(51) Int. Cl. H04B 7/204

(52) U.S. Cl. 370/319

(57) ABSTRACT

A communications system (301) is provided for carrying out spread spectrum communication. In a transmitting device (302) of the communications system 301, a spreading portion (310) spreads an input signal (d) using a spreading code (SC) and a transmitting portion (311, 306) transmits the signal (C) spread by the spreading portion (310). In a receiving device (314), a receiving portion (318, 325) receives the signal (Df) transmitted by the transmitting portion (311, 306), and a despreading portion (320) inversely spreads the signal (D) received by the receiving portion (318, 325) by using an inverse spreading code (ISC) corresponding to the spreading code (SC). The spreading code (SC) comprises a time spreading element (SFₜᵢₘₑ) indicating the amount of spreading in the time domain and a frequency spreading element (SF_{freq}) indicating the amount of spreading in the frequency domain. The time and frequency spreading elements (SFₜᵢₘₑ and SF_{freq}) in the spreading code (SC) are determined in dependence upon the number of different spreading codes in use.

This invention relates to a communications method, system and device for carrying out spread spectrum communication. The invention relates particularly to spread spectrum communication in which spreading can take place both in the time and frequency domains, for example in the Orthogonal Frequency Code Division Multiplexing (OFCDM) architecture.

A typical wireless network operates under challenging channel conditions. A wireless channel is far more unpredictable than a wireline channel because of factors such as multipath and shadow fading, Doppler spread, and time dispersion or delay spread. These factors are all related to variability introduced by the mobility of the user and the wide range of environments that may be encountered as a result.

Multipath fading is a result of the fact that a transmitted signal is reflected by objects in the environment between a transmitting device a receiving device (these objects can be buildings, trees, hills, or cars). The reflected signals arrive at the receiving device with random phase offsets, since each reflection generally follows a different path to reach the receiving device. The result is random, time-varying, signal fades as the reflections destructively (and constructively) superimpose on one another. The degree of cancellation, or fading, will depend on the delay spread of the reflected signals, as embodied by their relative phases, and their relative power.

Time dispersion represents distortion to the signal and is manifested by the spreading in time of the modulation symbols. This occurs when the coherence bandwidth of the channel is smaller than the modulation bandwidth. Time dispersion leads to inter-symbol interference (ISI), where the energy from one symbol spills over into another symbol, thereby increasing the BER.

In many instances, the fading due to multipath will be frequency selective, randomly affecting only a portion of the overall channel bandwidth at any given time. Frequency selective fading occurs when the channel introduces time dispersion and when the delay spread exceeds the symbol period. When there is no dispersion and the delay spread is less than the symbol period, the fading will be flat across frequency, thereby affecting all frequencies in the signal equally. Fading can lead to deep fades of more than 30 dB.

Doppler spread describes the changes in the channel introduced as a result of a user's mobility, and relative motion of objects in the channel. The Doppler effect has the effect of shifting, or spreading, the frequency components of a signal. The coherence time of the channel is the inverse of the Doppler spread, and is a measure of the speed at which the channel characteristics change. This in effect, determines the rate at which fading occurs. When the rate of change of the channel is high, this must be tracked by systems that require knowledge of the channel response at the receiver.

The statistics describing the fading signal amplitude are frequently characterized as either Rayleigh or Ricean. Rayleigh fading occurs when there is no line of sight (LOS) or dominant multipath component present in the received signal. If there is a LOS or dominant multipath component present, the fading follows a Ricean distribution. There is frequently no direct LOS path to a mobile because the very nature of mobile communications means that mobiles can be in a building, or behind one or other obstructions. This leads to Rayleigh fading, but also results in a shadow loss as well, generally caused by the signal having to pass through objects in its path. These conditions, along with the inherent variation in signal strength caused by changes in the distance between a mobile and cell site, result in a large dynamic range of signals, which can be as much as 70 dB.

In addition to the channel impairments discussed above, spectrum is a limited resource for wireless networks, and thus is reused within cellular systems. This means that the same frequencies are usually allocated to more than one cell. This increases overall system capacity at the expense of increased potential for interference between neighbouring cells occupying the same frequency allocation, as each channel is reused throughout the system. This generally results in cellular systems being interference limited.

Wireless networks employ a variety of techniques both to combat the above-described challenges of the wireless channel and to provide access to the network for multiple users. These techniques include diversity, equalization, channel or error correction coding, spread spectrum, interleaving, and more recently, space time coding.

Diversity is used to help mitigate multipath-induced fading. The simplest diversity technique, spatial diversity, involves the use of two or more receive antennas separated by some distance, say on the order of five to ten wavelengths for a base station, or a much smaller distance for a mobile terminal. The signal paths between the mobile and the base station will generally arrive from different directions or with different polarisations. Performance improvements are possible with this technique by taking advantage of the statistical likelihood that the resultant summation of these signals will be different at each antenna due to their spatial separation. When one antenna is in a fade, it is probable that the other one will generally not be.

Spread spectrum systems employ frequency diversity. With this technique, the signal is spread over a much larger bandwidth than is needed for transmission, and is typically greater than the coherence bandwidth of the channel. A wideband signal is more resistant to the effect of fading than is a narrowband signal since only a relatively small portion of the overall bandwidth will experience a fade at any given time.

There are two basic forms of spread spectrum; direct sequence code division multiple access (DS-CDMA), and frequency hopped code division multiple access (FH-CDMA). DS-CDMA systems, such as those used in IS-95 and 3G WCDMA exploit wideband channels and achieve frequency diversity through the use of a RAKE receiver. The 3G systems in Europe and the USA are based on DS-CDMA technology. The multipath signals that are received can be time and phase adjusted so that they can be coherently added together as long as the delay is more than one code symbol or chip time. The baseband information stream is mixed with a much higher rate pseudorandom spreading sequence code prior to transmission, and this effectively increases the signal bandwidth.

One problem with CDMA systems is that the code sequences are not truly orthogonal in the presence of multipath delay spread, and this is called multiple access interference. This results in interference between users within a cell and therefore limits the capacity of the cell.

Equalization is a technique used to overcome the effects of ISI resulting from time dispersion in the channel. Implemented at the receiver, the equalizer attempts to correct for the amplitude and phase distortions that occur in the channel and remove the effect of delayed symbols. These distortions change with time since the channel response is time varying. The equalizer must therefore adapt to, or track, the changing channel response in order to eliminate the ISI. In most cases, the equalizer is passed a fixed length training sequence at the start of each transmission, which enables it to characterize the channel at that time. A training sequence may also be sent periodically to maintain the equalizer's characterization of the channel.

Systems such as IS-136 and GSM typically must use such equalizers because their modulation symbol rate exceeds the coherence bandwidth of the channel (i.e., they operate in wideband channels). TDMA systems, such as these, assign one or more timeslots to a user for transmission. There is typically some guard time included between timeslots allow for time tracking errors at the mobile station and propagation delay. The use of equalizers adds to the complexity and costs of these systems, since equalization requires significant amounts of signal processing power. The need to transmit a fixed sequence of training bits also adds overhead to the communications, as do the pulse shaping filters that are employed to control transmission bandwidth. Unlike CDMA based systems, TDMA systems cannot use every frequency in every cell because of co-channel interference, and therefore need to be frequency planned. TDMA systems also have less inherent immunity against multipath fading than spread spectrum systems because they use a much narrower signal bandwidth. However, TDMA users within a cell are orthogonal to each other since they transmit at different times. Therefore, there is essentially no intra-cell interference.

OFDM is a technique that divides the spectrum into a number of equally-spaced tones or sub-carriers, and carries a portion of a user's information on each tone. OFDM can be considered as a form of frequency division multiplexing (FDM). However, OFDM has an additional property over basic FDM that each tone is orthogonal with every other tone. FDM typically requires there to be frequency guard bands between the frequencies so that they do not interfere with each other. On the other hand, OFDM allows the spectrum of each tone to overlap, and since they are orthogonal, they do not interfere with each other. By allowing the tones to overlap, the overall amount of spectrum required is reduced.

OFDM is a modulation technique in that it enables user data to be modulated onto the tones. The information is modulated onto a tone by adjusting the tone's phase, amplitude, or both, and Phase Shift Keying (PSK) and Quadrature Amplitude Modulation (QAM) are typically employed for this purpose. An OFDM system takes a data stream and splits it into N parallel data streams, each at a rate 1/N of the original rate. Each stream is then mapped to a tone at a unique frequency and combined together using the inverse Fast Fourier Transform (IFFT) to give the time domain waveform to be transmitted.

By creating slower parallel data streams, the bandwidth of the modulation symbol is effectively decreased, or equivalently, the duration of the modulation symbol is increased. This can greatly reduce, or even eliminate, ISI since typical multipath delay spread represents a much smaller proportion of the lengthened symbol time. In other words, the coherence bandwidth of the channel can be much smaller since the symbol bandwidth has been reduced, and the need for complex multi-tap time domain equalizers can largely be eliminated as a result. In typical implementations, a cyclic prefix is also pre-pended to each OFDM symbol to further mitigate or eliminate ISI.

OFDM can also be considered a multiple access technique since an individual tone or groups of tones can be assigned to different users. Multiple users share a given bandwidth in this manner, yielding a system called orthogonal frequency division multiple access, or OFDMA. Each user can be assigned a predetermined number of tones when they have information to send, or alternatively, a user can be assigned a variable number of tones based on the amount of information they have to send. The assignments are controlled by the media access control (MAC) layer, which schedules the resource assignments based on user demand.

OFDMA can be combined with frequency hopping to create a spread spectrum system, realizing the benefits of frequency diversity and interference averaging previously described for CDMA. In a frequency hopping spread spectrum system, each user's set of tones is changed after each time period (usually corresponding to a modulation symbol). By switching frequencies after each symbol time, the losses due to frequency selective fading are minimized. Although frequency hopping and direct sequence CDMA are different forms of spread spectrum, they achieve comparable performance in a multipath fading environment and provide similar interference-averaging benefits.

Starting from a traditional single-carrier DS-CDMA system, the most straightforward extension to a multi-carrier scenario is where a transmitter creates multiple data streams and spreads each of them by the same spreading code (processing each exactly as it would a single DS-CDMA system). It then transmits each of these on a different carrier frequency so that they are all transmitted in parallel. Detection of each individual stream is therefore identical to a DS-CDMA receiver. The inter-chip-interference caused by the dispersive multipath channel can be resolved by a RAKE receiver (for each carrier) which will identify and separate the delayed signal components, and coherently sum them together. Such a transmission scheme is called MC/DS-CDMA.

Multi-Carrier Code Division Multiple Access (MC-CDMA) is similar to OFDM, but data symbols are first spread as for CDMA with a spreading code having a spreading factor SF (representing the number of chips per data bit). Multiple users can therefore be supported by each user employing a different spreading code. The SF chips are then allocated to SF adjacent sub-carriers of an OFDM system, i.e. with no spreading in time. This can result in the loss of orthogonality between spreading codes at a receiver, as each sub-carrier experiences a different channel gain. However, the use of a suitable CP, as for ordinary OFDM, eliminates inter symbol interference (ISI).

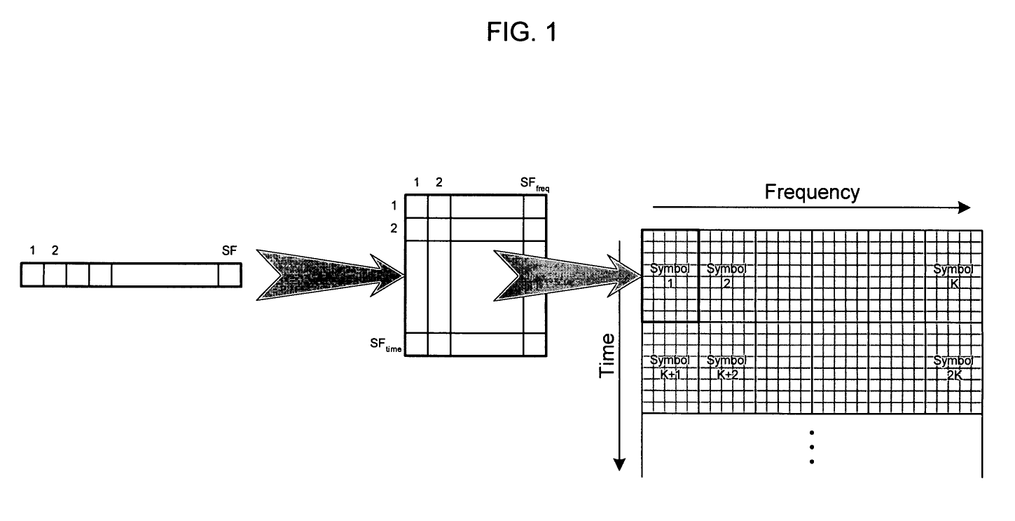

Orthogonal Frequency Code Division Multiplexing (OFCDM) is similar to MC-CDMA, but the chips resulting from spreading a single symbol can be arranged in blocks of frequency and time, so that each data symbol is allocated to a number of sub-carriers and a number of OFDM symbols on those sub-carriers. The dimensions of the block can be altered, for example the spreading can be SF in time and 1 in frequency, or vice versa, or some other combination making up SF chips. This is illustrated in FIG. 1 of the accompanying drawings. In the example of FIG. 1, the overall spreading factor SF illustrated in the left-most portion is allocated with a spreading factor SFₜᵢₘₑ in the time domain and SF_{freq} in the frequency domain, as illustrated in the middle portion of FIG. 1. As illustrated in the right-most portion of FIG. 1, the chips of the first symbol (Symbol 1) of user data are allocated across the first SF_{freq} subcarriers and the first SFₜᵢₘₑ OFDM symbols. The next symbol (Symbol 2) of user data is spread and allocated in a similar way, being allocated to the next SF_{freq} subcarriers and the same SFₜᵢₘₑ OFDM symbols. This is repeated until all the subcarriers are filled with the user's data (with Symbol K occupying the final SF_{freq} subcarriers). The SFₜᵢₘₑ OFDM symbols can then be transmitted, and the next SFₜᵢₘₑ OFDM symbols can then be allocated and transmitted in the same way. Thus a single user data fills all subcarriers (N/SF_{freq} must be an integer, in this example equal to K). In the right-most portion of FIG. 1, the allocation is schematically shown as SF_{freq}=5 and SFₜᵢₘₑ=8 by the grid division illustrated within each symbol. MC-CDMA can be described as an OFCDM system where symbols are always spread by a factor of SF in frequency and 1 in time. OFCDM is described, for example, in EP-A-1128592.

In “Broadband Packet Wireless Access Based on VSF—OFCDM and MC/DS-CDMA” (H. Atarashi, N. Maeda, A. Abeta and M. Sawahashi, in Proc. PIMRC, Lisbon, September, 2002) a broadband packet wireless access system is proposed which employs Variable Spreading Factor Orthogonal Frequency and Code Division Multiplexing (VSF—OFCDM) with two-dimensional spreading that prioritizes time domain spreading in the forward link and Multi-carrier/DS-CDMA (MC/DS-CDMA) in the reverse link for the system beyond IMT-2000. Simulation results show that the disclosed VSF-OFCDM scheme using the proposed radio link parameters achieves a throughput above 100 Mbps at the average received signal energy per symbol to background noise power spectrum density ratio (Eₛ/N₀) of approximately 13 dB (101.5-MHz bandwidth, without antenna diversity reception, 12-path Rayleigh fading channel). Furthermore, MC/DS-CDMA realizes a throughput above 20 Mbps at the average received Eₛ/N₀ of approximately 8 dB (40-MHz bandwidth, with antenna diversity reception, six-path Rayleigh fading channel).

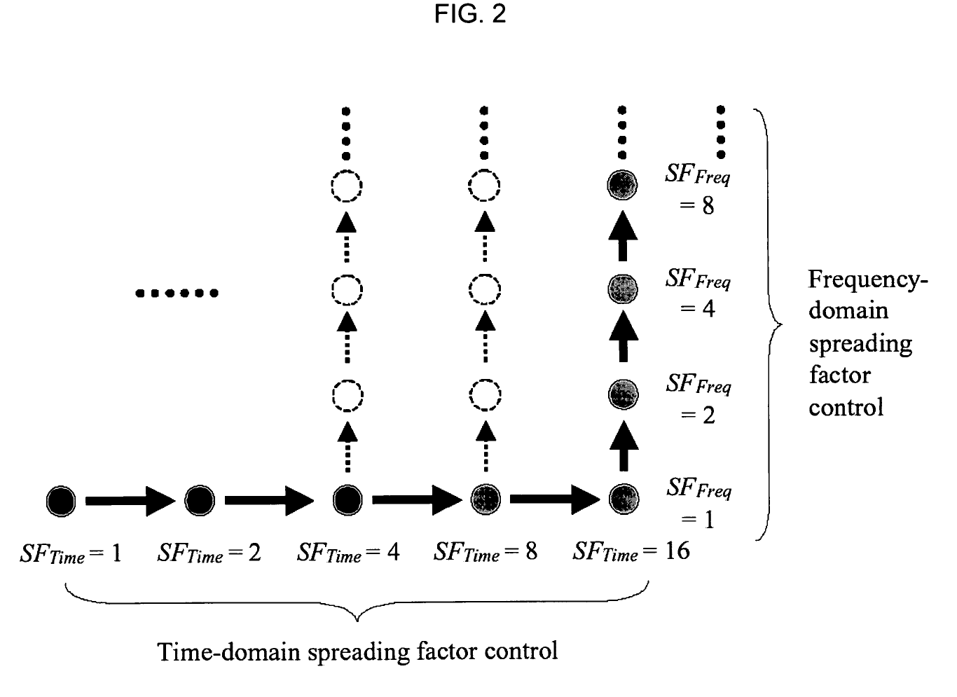

The method disclosed in Atarashi et al for determining the arrangement of chips in time and frequency is as follows. In order to maintain orthogonality between spreading codes, time domain spreading is prioritised, with some frequency domain spreading then being allowed, either: (a) if the spreading factor in time, SFₜᵢₘₑ, has reached 16, and a total spreading factor, SF, of greater than 16 is required; or (b) if the SNR and modulation order is low (e.g. Quadrature Phase Shift Keying QPSK), then setting SF_{freq}>1 could give some frequency diversity without introducing too much inter-code interference. This scheme is illustrated in FIG. 2 of the accompanying drawings.

The method described in Atarashi et al for selecting the values for SFₜᵢₘₑ and SF_{freq}, can lead to sub-optimum performance in certain instances, and it is desirable to provide an alternative method to reduce the E_{b}/N₀ required to achieve a specified block error rate.

According to a first aspect of the present invention there is provided a communications method for carrying out spread spectrum communication, comprising the steps of: spreading an input signal using a spreading code; transmitting the signal spread in the spreading step; receiving the signal transmitted in the transmitting step; inversely spreading the signal received in the receiving step by using an inverse spreading code corresponding to the spreading code, wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

The time spreading element may comprise a time spreading code having a time spreading factor indicating the amount of spreading to be performed in the time domain. The time spreading codes in use may be orthogonal to each other.

A time spreading element may have as a possible indication that no spreading is to be performed in the time domain.

The frequency spreading element may comprise a frequency spreading code having a frequency spreading factor indicating the amount of spreading to be performed in the frequency domain.

A frequency spreading element may have as a possible indication that no spreading is to be performed in the frequency domain.

The spreading code may have an overall spreading factor indicating the overall amount of spreading to be performed in the time and frequency domains. The overall spreading factor may remain constant during a predetermined period while the time and frequency spreading amount indications are changed.

Each spreading code in use may have the same time and frequency spreading amount indications. The same modulation scheme may be used in the transmitting step performed for each user.

The time and frequency spreading amount indications may be changed after a predetermined number of new spreading codes are allocated. The predetermined number may be one.

The time and frequency spreading amount indications may be changed at predetermined time intervals.

Spreading in the frequency domain may be over one or more of a plurality of frequency sub-carriers. The frequency spreading amount indication may indicate the number of frequency sub-carriers to be used. The frequency sub-carriers may be sub-carriers in an Orthogonal Frequency Division Multiplexing scheme.

Spread spectrum communication may be performed according to the Orthogonal Frequency Code Division Multiplexing scheme.

The number of different spreading codes in use may be equal to the number of users.

The number of different spreading codes in use may be equal to the number of active users. The time and frequency spreading elements in the spreading code may be determined in dependence upon the number of different spreading codes in active use. The number of different spreading codes in use may be equal to the number of spreading codes allocated to users. Where the communications method is used in a cellular communications system, the time and frequency spreading elements may be determined on a cell-by-cell basis in dependence upon the number of different spreading codes in use for each cell of the system.

The time and frequency spreading elements may also indicate the form of spreading in the time and frequency domains respectively. The time/frequency spreading code mentioned above may indicate the form of spreading in the time/frequency domain.

The communications method may be carried out for both transmission attempts in a hybrid automatic repeat request method for use in a communications system comprising a transmitting device having a plurality of transmit antennas and a receiving device having a plurality of receive antennas, the hybrid automatic repeat request method comprising determining that an error has occurred in a first data transmission attempt in which data signals are transmitted from a first selection of transmit antennas for receipt at a second selection of receive antennas, and in response to such a determination performing a second data transmission attempt in which the data signals are re-transmitted from a third selection of transmit antennas for receipt at a fourth selection of receive antennas, performing a reconfiguration operation to ensure that the channel conditions between the transmit and receive antennas selected for the first transmission attempt are different to the channel conditions between the transmit and receive antennas selected for the second transmission attempt, and further comprising recovering data at the receiving device using information from the first and second transmission attempts.

When it is stated that an operation is performed on a signal from a previous step, this is to be understood as including the possibility of performing that operation on a signal derived from the signal from the previous step.

According to a second aspect of the present invention there is provided a communications system for carrying out spread spectrum communication, comprising: means for spreading an input signal using a spreading code; means for transmitting the signal spread by the spreading means; means for receiving the signal transmitted by the transmitting means; means for inversely spreading the signal received by the receiving means by using an inverse spreading code corresponding to the spreading code, wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

According to a third aspect of the present invention there is provided a transmitting method for spread spectrum communication, comprising the steps of: spreading an input signal using a spreading code, and transmitting the signal spread in the spreading step; wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

According to a fourth aspect of the present invention there is provided a transmitting device for spread spectrum communication, comprising means for spreading an input signal using a spreading code, and means for transmitting the signal spread by the spreading means; wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

According to a fifth aspect of the present invention there is provided a receiving method for spread spectrum communication, comprising the steps of: receiving a signal that has been spread with a spreading code, and inversely spreading the signal received in the receiving step by using an inverse spreading code corresponding to the spreading code; wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

According to a sixth aspect of the present invention there is provided a receiving device for spread spectrum communication, comprising means for receiving a signal that has been spread with a spreading code, and means for inversely spreading the signal received by the receiving means by using an inverse spreading code corresponding to the spreading code; wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

According to a seventh aspect of the present invention there is provided an operating program which, when run on a communications device, causes the device to carry out a method according to the third or fifth aspect of the present invention.

According to an eighth aspect of the present invention there is provided an operating program which, when loaded into a communications device, causes the device to become one according to the fourth or sixth aspect of the present invention.

The operating program may be carried on a carrier medium, which may be a transmission medium or a storage medium.

Reference will now be made, by way of example, to the accompanying drawings, in which:

FIG. 1, discussed hereinbefore, is a schematic illustration of the arrangement of spread chips in blocks of frequency and time in the Orthogonal Frequency Code Division Multiplexing (OFCDM) scheme;

FIG. 2, also discussed hereinbefore, illustrates one prior art method for selecting the time and frequency domain spreading factors in OFCDM;

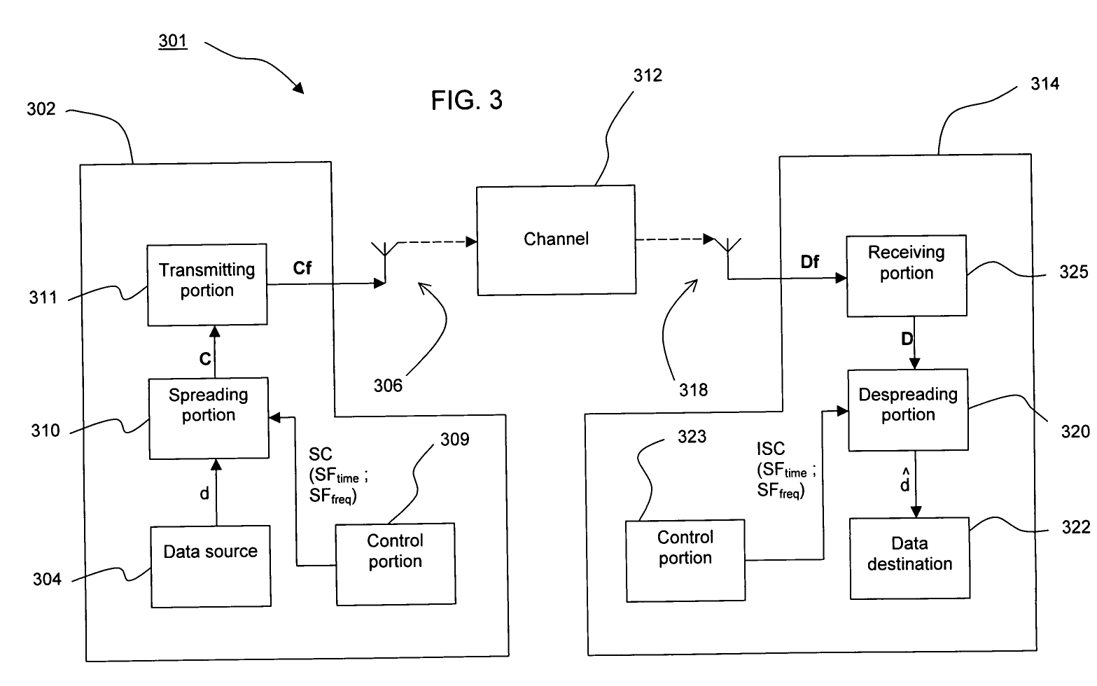

FIG. 3 is a block diagram illustrating a communications system according to a first embodiment of the present invention;

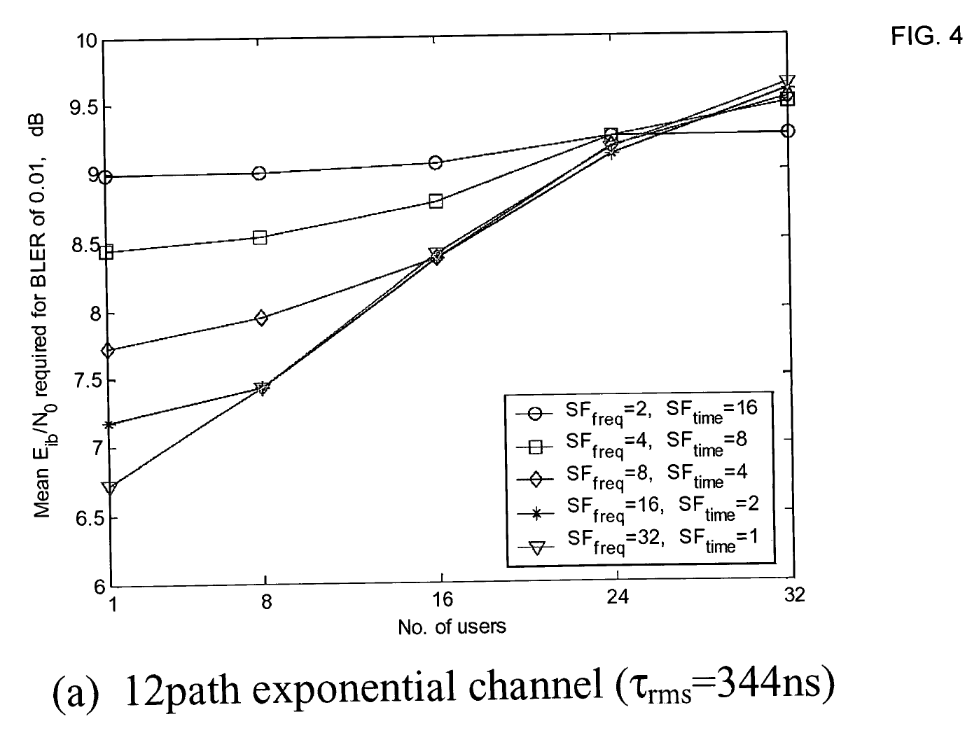

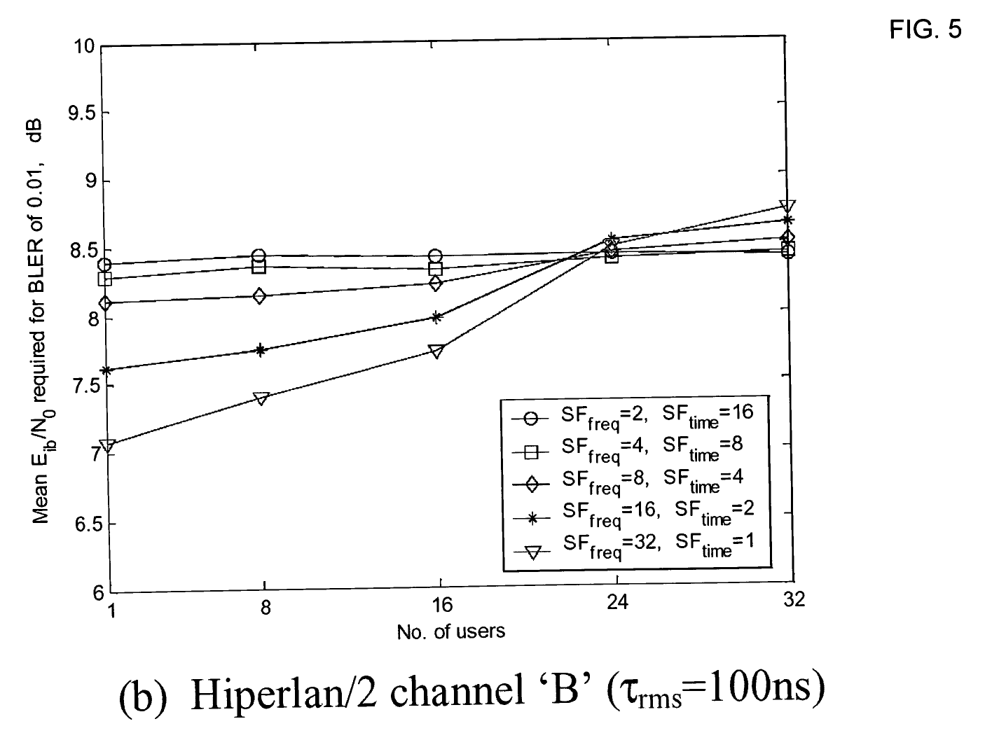

FIGS. 4 and 5 show the results of simulations using QPSK modulation for two different delay spreads;

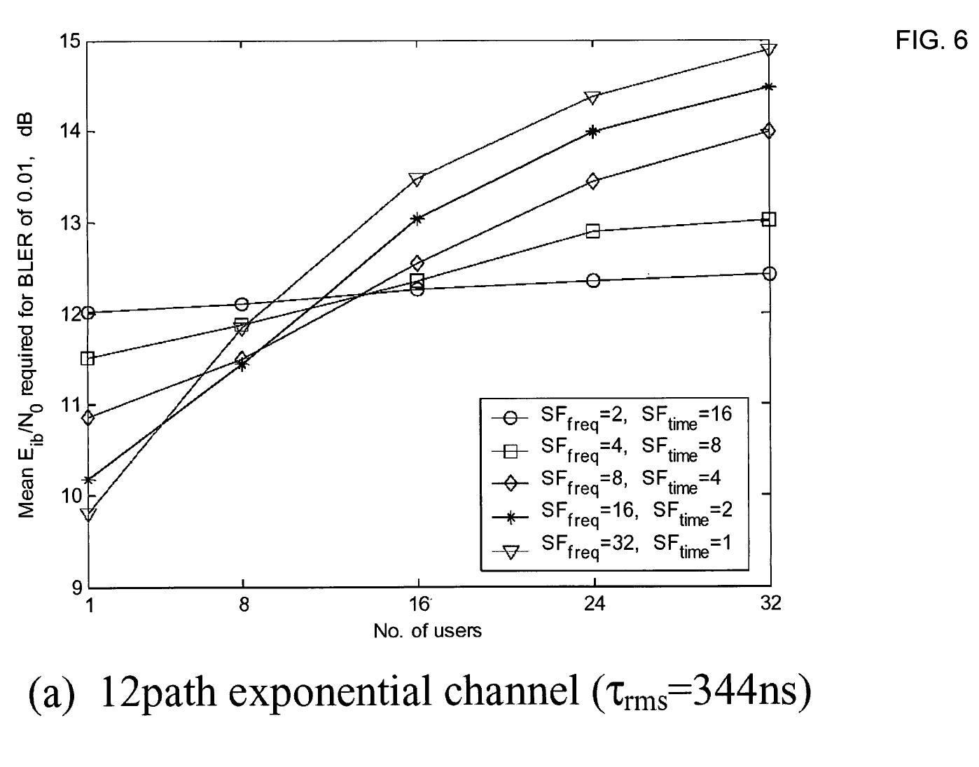

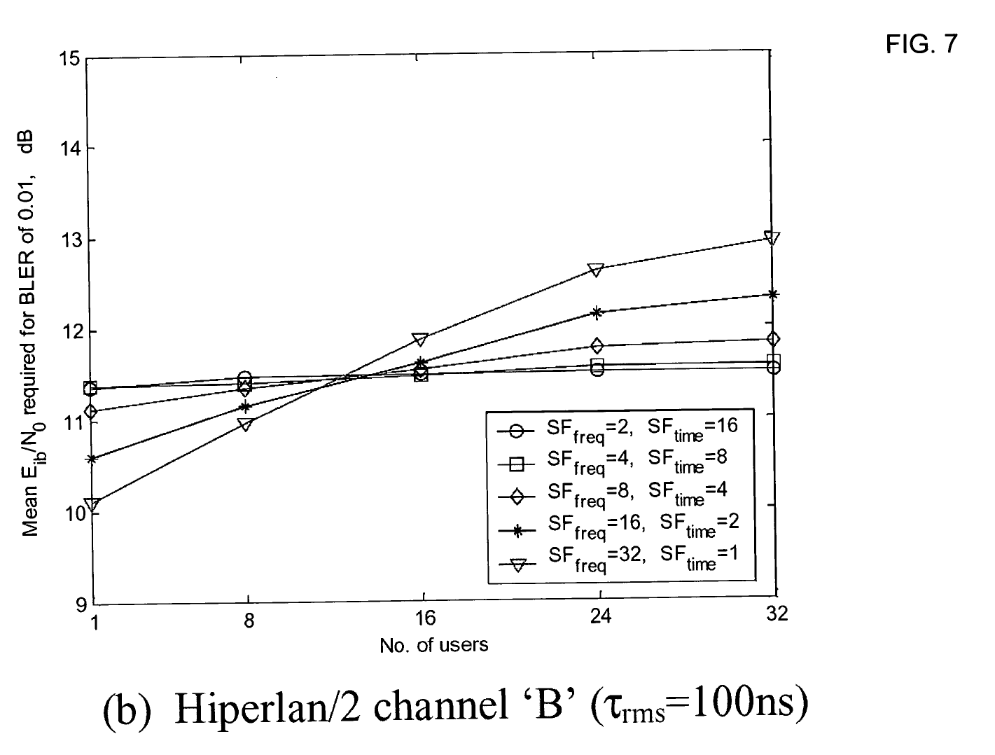

FIGS. 6 and 7 show the results of simulations using 16QAM modulation for two different delay spreads; and

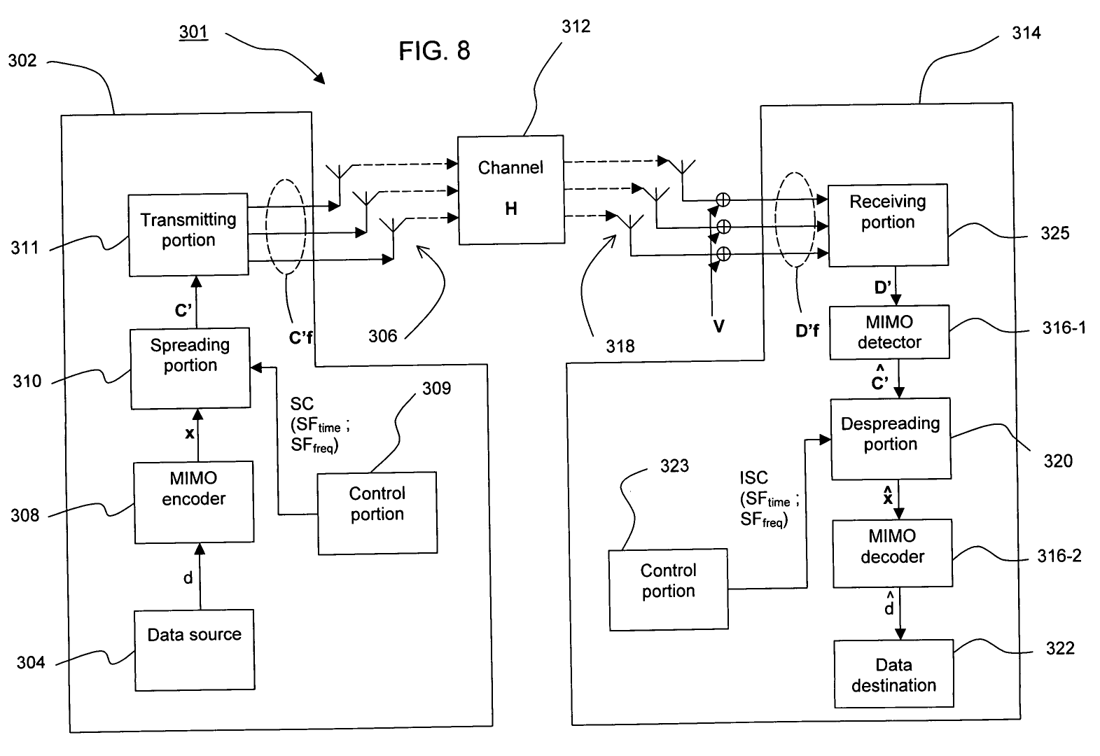

FIG. 8 is a block diagram illustrating a communications system according to a second embodiment of the present invention.

FIG. 3 is a schematic diagram illustrating a communications system 301 according to a first embodiment of the present invention. The communications system 301 comprises a transmitting device 302 and a receiving device 314. The transmitting device 302 comprises a data source 304, a spreading portion 310, control portion 309, a transmitting portion 311 and a transmit antenna 306. The receiving device 314 comprises a data destination 322, a despreading (or inverse spreading) portion 320, control portion 323, a receiving portion 325 and a receive antenna 318. Transmissions between the transmitting device 302 and the receiving device 314 are over a channel represented in FIG. 3 by the channel 312.

In operation, the data source 304 provides a data symbol d to the spreading portion 310. The spreading portion 310 acts under control of the control portion 309, receiving a spreading code SC therefrom for use in spreading the data symbol d received by the spreading portion 310 as an input signal. The spreading code SC comprises a time spreading element indicating the amount of spreading in the time domain and a frequency spreading element indicating the amount of spreading in the frequency domain. In this embodiment the spreading portion 310 operates according to the OFCDM scheme described in detail above with reference to FIG. 1, so that the time spreading element of the spreading code SC indicates the spreading factor SFₜᵢₘₑ in the time domain and the frequency spreading element indicates the spreading factor SF_{freq} in the frequency domain. The method by which SFₜᵢₘₑ and SF_{freq} are determined will be explained in more detail below.

The spreading code SC is used to spread the data symbol d across the time and/or frequency domains according to SFₜᵢₘₑ and SF_{freq} to produce SF=SF_{freq}×SFₜᵢₘₑ chips which are conveniently shown here arranged in a SF_{freq}×SFₜᵢₘₑ chip matrix C. Each of the SF_{freq} rows in the chip matrix C corresponds to a particular frequency sub-carrier, and each row contains a chip sequence in the time domain of length SFₜᵢₘₑ. If necessary, further data symbols d are spread by the spreading portion 310 to make up all the N subcarriers of the OFDM system as described above with reference to FIG. 1 and included in the final N×SFₜᵢₘₑ chip matrix C.

The chip matrix C is then passed to the transmitting portion 311, which modulates chips onto the appropriate sub-carriers and produces OFDM symbols Cf for transmission from the transmit antenna 306 over the channel 312.

After passing across the channel 312, the signal is received at the receiving device 314 by the receive antenna 318 as signal Df and passed to the receiving portion 325. The receiving portion 325 demodulates the signal Df effectively to produce a received N×SFₜᵢₘₑ chip matrix D corresponding to the chip matrix C, and this is then subject to despreading (inverse spreading) using an inverse spreading code ISC, corresponding to the spreading code SC, passed to the despreading portion 320 by the control portion 323 to produce an estimate \hat{d} of the data symbol or symbols d.

As an alternative to the usual OFCDM scheme in which spreading is carried out and then allocated to the time and frequency domains as in FIG. 1, time and frequency spreading could be carried out sequentially. The time spreading element of the spreading code SC could comprise a time spreading code of length SFₜᵢₘₑ (the time spreading factor), with the time spreading element indicating both the amount of spreading in the time domain (indicated by SFₜᵢₘₑ) and the form of spreading (indicated by the type of time spreading code). The frequency spreading element of the spreading code SC would comprise a frequency spreading code having a frequency spreading factor SF_{freq} which indicates the amount of spreading to be performed in the frequency domain, or the number of frequency sub-carriers across which the data symbol d is to be spread.

In one prior art method described above, time domain spreading is prioritised, with some frequency domain spreading then being allowed according to certain criteria. In an embodiment of the present invention, SF_{freq} and SFₜᵢₘₑ are instead determined based on the number of different spreading codes in use. If each user of the system 301 is allocated a single unique spreading code, this means that SF_{freq} and SFₜᵢₘₑ are determined based on the number of different users of the communications system 301. If the communications system 301 is a cellular communications system, then SF_{freq} and SFₜᵢₘₑ would be determined based on the number of different users in a particular cell. If a user or spreading code has not been active for a predetermined period of time then that user and spreading code can be disregarded for the purpose of selecting SF_{freq} and SFₜᵢₘₑ. In this embodiment, the control portion 309 in the transmitting device 302 selects SF_{freq} and SFₜᵢₘₑ based on the number of different spreading codes using a pre-generated look-up table, which will be described in more detail below.

The rationale behind choosing SF_{freq} and SFₜᵢₘₑ based on the number of different spreading codes in use (or equivalently, in most cases, the number of users) will now be explained with reference to FIGS. 4 to 7, which show the results of simulations for various modulation schemes and channel models. In these simulations, each user has a single spreading code, and the basestation always transmits to all active users. All graphs show the mean E_{ib}/N₀ (dB) (Ratio of energy per information bit to noise variance) required to achieve a Block Error Rate (BLER) of 0.01, plotted against the number of users in the system, for various combinations of SF_{freq} and SFₜᵢₘₑ (for each combination the total spreading factor SF is 32). In FIGS. 4 and 5 the QPSK modulation scheme was used, while in FIGS. 6 and 7 the 16QAM modulation scheme was used. The signals for all users employ the same modulation scheme. For FIGS. 4 and 6 a 12-path exponential channel with an r.m.s. delay spread τᵣₘₛ of 344 ns was used, while for FIGS. 5 and 7 a Hiperlan/2 channel ‘B’ with an r.m.s. delay spread τᵣₘₛ of 100 ns was used.

The simulation results in FIGS. 4 to 7 show that, for small numbers of users (fewer than about 24 for QPSK modulation shown in FIGS. 4 and 5, and fewer than about 12 for 16QAM modulation shown in FIGS. 6 and 7) the performance generally improves with increasing SF_{freq} (decreasing SFₜᵢₘₑ). On the other hand, for large numbers of users (more than about 24 for QPSK modulation shown in FIGS. 4 and 5 and more than about 12 for 16QAM modulation shown in FIGS. 5 and 7) the performance generally improves with increasing SFₜᵢₘₑ (decreasing SF_{freq}).

Therefore, given a total spreading factor SF, for small numbers of users the control portion 309 would probably select SF_{freq}=SF and SFₜᵢₘₑ=1 from the look-up table, while for large numbers of users (as the number of users approaches SF) the look-up table the control portion 309 would probably select SF_{freq}=1 and SFₜᵢₘₑ=SF from the look-up table (the exact values in the look-up table would depend upon various system parameters as described below). For example, using the system parameters shown in FIGS. 4 and 5, SF_{freq}=32 and SFₜᵢₘₑ=1 would be chosen when the number of users is less than 24, whereas SF_{freq}=2 and SFₜᵢₘₑ=16 would be chosen if the number of users is greater than 24. Depending on the system parameters used to create the look-up table, near the cross-over point (or elsewhere) other intermediate values of SF_{freq} and SFₜᵢₘₑ might be chosen, for example SF_{freq}=8 and SFₜᵢₘₑ=4.

From a comparison of FIG. 4 with FIG. 5, and a comparison of FIG. 6 with FIG. 7, it can be observed that for a fixed modulation and coding scheme (i.e. the same for all users), changes to the delay spread of the channel make very little difference to the choice of the best spreading parameters. It is apparent that changing the channel conditions (delay spread) essentially just has a vertical scaling effect on the curves. For example, in the case of flat fading (delay spread=0), there would be no difference between time and frequency spreading (assuming a stationary, or quasi-stationary channel) so that all curves would be horizontal and lie on top of each other. As the delay spread increases, the cross-over point of the curves appears to remain substantially fixed, but at either extreme of the curves (one user against 32 users) the discrepancy between time and frequency spreading increases. This implies that it does not matter that the channel characteristics between the transmitting and receiving devices 302 and 314 are different for different users. If the transmitting device 302 selects the spreading parameters solely on the number of users (spreading codes in use), it will generally achieve the combination that is best for all users, and if not then the values will be close to optimum and the performance degradation will be small.

The look-up table would generally be generated by simulation at the time of system design, with the values stored in it being a function of system parameters and not channel properties. A different table would have to be created and stored for each different set of parameters that the system may employ, for example the modulation scheme used. In this respect, a comparison of FIGS. 4 and 5 with FIGS. 6 and 7 shows the difference in the performance cross-over point when changing from QPSK to 16QAM modulation. However, there would probably be redundancy in this information, and once generated it would be possible to limit the amount of storage space required. In any case, a scheme embodying the present invention would generally be used in the downlink direction, so that the look-up table storage and maintenance would only be required at the base-station end of a link.

Since this scheme would generally be used for downlink transmission, the choice of spreading parameters can be varied as often as required (as the number of code-multiplexed signals increases or decreases), with minimal impact on the base-station's resources. The current parameter selection can be indicated to the various users via a pilot channel, packet header information or some other broadcast means. By ensuring that the spreading arrangement in time and frequency is constantly adjusted, according to the number of code-multiplexed signals, performance is always kept close to optimum. This can lead to a performance improvement of several dBs over the prior art scheme where spreading in the time domain is prioritised over spreading in the frequency domain. This can reduce the E_{b}/N₀ required to achieve a specified block error rate, and in a practical system this can improve link reliability and robustness, and decrease the probability of requiring retransmissions (thus increasing throughput) and so on.

Several options have been presented above as to when and how often the transmitting device or base station would change the spreading arrangement. Another alternative would be that the base station changes the spreading arrangement for each packet, depending upon how many code-multiplexed signals are currently being transmitted. Other schemes would be readily apparent to the skilled person.

A scheme embodying the present invention is generally only suitable when adaptive modulation and coding is not applied, so that all users employ the same parameters.

FIG. 8 is a schematic diagram illustrating a communications system 301 according to a second embodiment of the present invention. The second embodiment is similar to the first embodiment, with like-numbered parts performing the same or corresponding functions, and a detailed description is not therefore necessary. The second embodiment differs from the first embodiment in that it is applied to a multiple-input multiple-output (MIMO) architecture rather than a single antenna architecture. In this regard, the second embodiment has, in addition to those parts shown and described above with reference to FIG. 3, a MIMO encoder 308 in the transmitting device 302 disposed between the data source 304 and the spreading portion 310, a MIMO detector 316-1 in the receiving device 314 disposed between the receiving portion 325 and the despreading portion 320, and a MIMO decoder 316-2 in the receiving device 314 disposed between the despreading portion 320 and the data destination 322. The transmitting device 302 also has a plurality T of transmit antennas 306, while the receiving device 314 has a plurality R of receive antennas 318.

In the transmitting device 302, the data source 304 provides the information symbol vector d to the MIMO encoder 308 which encodes the symbol vector d to a T-dimension symbol vector x, and this symbol vector x is then processed by the spreading portion 310. The difference between the first and second embodiments is that, in the second embodiment, an extra dimension is introduced to the output of the spreading portion 310, being a “transmit antenna” dimension. Thus, each of the T symbols in x are spread by the spreading portion as described above in the first embodiment, giving an output chip matrix C′ having an extra dimension as compared with C. The symbol vector x is spread in time and frequency to give a (T×SFₜᵢₘₑ)×SF_{freq} transmit chip matrix C′ (T rows and SFₜᵢₘₑ columns, with an extra dimension in the SF_{freq} direction) and then modulated onto the sub-carriers by the transmitting portion 311 to give the transmitted signals C′f. In this respect, it is convenient here to consider the transmit antenna and time dimensions in isolation as a (T×SFₜᵢₘₑ) matrix C, with SF_{freq} separate such matrices for the frequency sub-carriers. The various frequencies in the frequency dimension are therefore considered separately and in turn in the analysis below.

The channel conditions of the channel 312 between the transmitting device 302 and the receiving device 314 can be represented by a R×T channel response matrix H(R rows and T columns), with the noise contribution being represented by a R×SFₜᵢₘₑ matrix V. A separate H and V is used for each frequency sub-carrier.

Using this channel model, an R×SFₜᵢₘₑ chip matrix D received at the MIMO detector 316-1 for each sub-carrier (after demodulation by the receiving portion 325), can be represented as:
D=HC+V.

These signals D are then input to the MIMO detector 316-1. An example of such a MIMO detector 316-1 is to generate a linear estimator matrix W equal to H⁻¹ so that an estimate Ĉ of the transmit chip matrix C is given by:
Ĉ=WD.

This is performed separately for each sub-carrier. The estimates Ĉ of the transmit chip matrix for each sub-carrier are then passed to the despreading portion 320 which performs the reverse of the spreading performed by the spreading portion 310 for each transmit antenna, resulting in an estimate \hat{x} of the T-dimensional symbol vector x. This estimate is then decoded by the MIMO decoder 316-2 by performing the reverse of the encoding operation performed by the MIMO encoder 308 to produce an estimate \hat{d} of the original data symbol vector d, and this estimate \hat{d} is passed to the data destination 322. Selection of SFₜᵢₘₑ and SF_{freq} is performed as for the first embodiment.

Practical MIMO systems can benefit from the selection and use of a set of antennas from a total greater than the number of transmit and/or receive hardware chains. If, for example, a system had four transmit and four receive radio frequency (RF) chains, but had eight antennas available at each end, it could choose which four out of the eight antennas would give it the best performance. This allows hardware (space, cost and power) savings to be made, since only four transmit and four receive RF chains would be required to be built, whilst still gaining some of the benefits of having a larger number of antennas. The only duplication is the antenna elements themselves (which are relatively low cost), and the small overhead introduced by the additional RF switching (which is still more economical than multiple transmit and receive chains). This use of antenna subset selection could be employed at the transmitter, the receiver, or both. The Hybrid-ARQ method disclosed in our co-pending United Kingdom application no. 0404450.9 can also be used in conjunction with the second embodiment of the present invention, and that disclosure is incorporated herein by reference.

It will be appreciated that operation of one or both of the transmitting device 302 and receiving device 314 can be controlled by a program operating on the device. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

Although embodiments of the present invention have been described above in relation to the OFCDM architecture, it will be appreciated that the determination of time and frequency spreading amounts based on the number of users or spreading codes is applicable to other architectures in which spreading can be performed in both the time and frequency domains. For example, an embodiment of the present invention is applicable to MC-CDMA.

1. A communications method for carrying out spread spectrum communication, comprising the steps of: spreading an input signal using a spreading code; transmitting the signal spread in the spreading step; receiving the signal transmitted in the transmitting step; inversely spreading the signal received in the receiving step by using an inverse spreading code corresponding to the spreading code, wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

2. A communications method as claimed in claim 1, wherein the time spreading element comprises a time spreading code having a time spreading factor indicating the amount of spreading to be performed in the time domain.

3. A communications method as claimed in claim 2, wherein the time spreading codes in use are orthogonal to each other.

4. A communications method as claimed in claim 1, wherein a time spreading element has as a possible indication that no spreading is performed in the time domain.

5. A communications method as claimed in claim 1, wherein the frequency spreading element comprises a frequency spreading code having a frequency spreading factor indicating the amount of spreading to be performed in the frequency domain.

6. A communications method as claimed in claim 1, wherein a frequency spreading element has as a possible indication that no spreading is performed in the frequency domain.

7. A communications method as claimed in claim 1, wherein the spreading code has an overall spreading factor indicating the overall amount of spreading to be performed in the time and frequency domains.

8. A communications method as claimed in claim 7, wherein the overall spreading factor remains constant during a predetermined period while the time and frequency spreading amount indications are changed.

9. A communications method as claimed in claim 1, wherein each spreading code in use has the same time and frequency spreading amount indications.

10. A communications method as claimed in claim 1, wherein the same modulation scheme is used in the transmitting step performed for each user.

11. A communications method as claimed in claim 1, wherein the time and frequency spreading amount indications are changed after a predetermined number of new spreading codes are allocated.

12. A communications method as claimed in claim 11, wherein the predetermined number is one.

13. A communications method as claimed in claim 1, wherein the time and frequency spreading amount indications are changed at predetermined time intervals.

14. A communications method as claimed in claim 1, wherein spreading in the frequency domain is over one or more of a plurality of frequency sub-carriers.

15. A communications method as claimed in claim 14, wherein the frequency spreading amount indication indicates the number of frequency sub-carriers to be used.

16. A communications method as claimed in claim 14, wherein the frequency sub-carriers are sub-carriers in an Orthogonal Frequency Division Multiplexing scheme.

17. A communications method as claimed in claim 1, wherein spread spectrum communication is performed according to the Orthogonal Frequency Code Division Multiplexing scheme.

18. A communications method as claimed in claim 1, wherein the number of different spreading codes in use is equal to the number of users.

19. A communications method as claimed in claim 1, wherein the number of different spreading codes in use is equal to the number of active users.

20. A communications method as claimed in claim 1, wherein the time and frequency spreading elements in the spreading code are determined in dependence upon the number of different spreading codes in active use.

21. A communications method as claimed in claim 1, wherein the number of different spreading codes in use is equal to the number of spreading codes allocated to users.

22. A communications method as claimed in claim 1, for use in a cellular communications system wherein the time and frequency spreading elements are determined on a cell-by-cell basis in dependence upon the number of different spreading codes in use for each cell of the system.

23. A communications method as claimed in claim 1, wherein the time and frequency spreading elements also indicate the form of spreading in the time and frequency domains respectively.

24. A communications method as claimed in claim 2, wherein the time and frequency spreading elements also indicate the form of spreading in the time and frequency domains respectively, and the time/frequency spreading code indicates the form of spreading in the time/frequency domain.

25. A communications method as claimed in claim 5, wherein the time and frequency spreading elements also indicate the form of spreading in the time and frequency domains respectively, and the time/frequency spreading code indicates the form of spreading in the time/frequency domain.

26. A communications method as claimed in claim 1, being carried out for both transmission attempts in a hybrid automatic repeat request method for use in a communications system comprising a transmitting device having a plurality of transmit antennas and a receiving device having a plurality of receive antennas, the hybrid automatic repeat request method comprising determining that an error has occurred in a first data transmission attempt in which data signals are transmitted from a first selection of transmit antennas for receipt at a second selection of receive antennas, and in response to such a determination performing a second data transmission attempt in which the data signals are re-transmitted from a third selection of transmit antennas for receipt at a fourth selection of receive antennas, performing a reconfiguration operation to ensure that the channel conditions between the transmit and receive antennas selected for the first transmission attempt are different to the channel conditions between the transmit and receive antennas selected for the second transmission attempt, and further comprising recovering data at the receiving device using information from the first and second transmission attempts.

27. A communications system for carrying out spread spectrum communication, comprising: means for spreading an input signal using a spreading code; means for transmitting the signal spread by the spreading means; means for receiving the signal transmitted by the transmitting means; means for inversely spreading the signal received by the receiving means by using an inverse spreading code corresponding to the spreading code, wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

28. A transmitting method for spread spectrum communication, comprising the steps of: spreading an input signal using a spreading code, and transmitting the signal spread in the spreading step; wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

29. A transmitting device for spread spectrum communication, comprising means for spreading an input signal using a spreading code, and means for transmitting the signal spread by the spreading means; wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

30. A receiving method for spread spectrum communication, comprising the steps of: receiving a signal that has been spread with a spreading code, and inversely spreading the signal received in the receiving step by using an inverse spreading code corresponding to the spreading code; wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

31. A receiving device for spread spectrum communication, comprising means for receiving a signal that has been spread with a spreading code, and means for inversely spreading the signal received by the receiving means by using an inverse spreading code corresponding to the spreading code; wherein the spreading code comprises a time spreading element indicating the amount of spreading in the time domain and a frequency spreading element indicating the amount of spreading in the frequency domain, and wherein the time and frequency spreading elements in the spreading code are determined in dependence upon the number of different spreading codes in use.

32. An operating program which, when run on a communications device, causes the device to carry out a method as claimed in claim 28.

33. An operating program which, when run on a communications device, causes the device to carry out a method as claimed in claim 29.

34. An operating program which, when loaded into a communications device, causes the device to become one as claimed in claim 30.

35. An operating program which, when loaded into a communications device, causes the device to become one as claimed in claim 31.

36. An operating program as claimed in claim 32, carried on a carrier medium.

37. An operating program as claimed in claim 33, carried on a carrier medium.

38. An operating program as claimed in claim 34, carried on a carrier medium.

39. An operating program as claimed in claim 35, carried on a carrier medium.
